(19) United States
(12) Patent Application Publication
(10) Pub. No.: US 2017/0150108 A1
(43) Pub. Date: May 25, 2017

(54) Autostereoscopic Virtual Reality Platform

(71) Applicant: Liang Kong, Hu Zhou City (CN)

(72) Inventor: Liang Kong, Hu Zhou City (CN)

(21) Appl. No.: 15/316,803

(22) PCT Filed: May 18, 2015
(86) PCT No.: PCT/CN2015/079147

§ 371 Date: Dec. 6, 2016

(30) Foreign Application Priority Data
Jun. 23, 2014 (GB) 1411120.7
Mar. 24, 2015 (CN) 201510136329

(51) Int. Cl. H04N 9/31; G06F 3/01; G03H 1/00; H04N 13/04

(52) U.S. Cl. CPC H04N 9/3147; H04N 13/0488; H04N 9/3194; G06F 3/016; G06F 3/011; G03H 1/0005

(57) ABSTRACT

A virtual reality display system 10 comprises a first display, a second display and a third display, the first display having a three-dimensional display volume 18 and including a plurality of projectors 12, 14, 16 for projecting a three-dimensional image 102, 104, 106, 108 into the display volume 18, the second display including at least one substantially translucent display screen 20, 22, 24, 26, 28 and means for displaying an image on the display screen, and the third display being a holographic display.

The present invention relates to a virtual reality display system, and to a virtual reality platform making use of three-dimensional, two-dimensional and holographic displays.

### BACKGROUND TO THE INVENTION

Virtual reality displays enable a person to view, and in some cases interact with, a virtual world, in a way which mimics the experience of interacting with the real world. For example, a viewer can move his head in order to change the direction in which he is looking, or to see around a corner or see past an object. Typically, such systems include head-mounted displays which include motion-tracking apparatus, and a processor which tracks the motion of the user and adjusts the display appropriately.

Display systems based on head-mounted displays can provide an immersive experience to an extent, but the only display screen is always very close to the viewer's eyes. Although some limited three-dimensional effects are possible, the display is never completely realistic.

Another type of three-dimensional display system is described in the Applicant's granted British Patent GB 2497612. The display system described includes a plurality of projectors which are able to project an image of a three-dimensional object into a three-dimensional display volume, which may include a cloud of particles. A viewer can move within the display volume to view the image from all angles. This provides a more realistic three-dimensional effect than is possible from a head-mounted display. However, the viewer's experience is limited by the size of the display volume, and in particular it is very difficult to provide a large depth of view, including midground and background scenes, without a correspondingly large display volume which is likely to be impractical or at least very expensive.

It is an object of the invention to provide an improved virtual reality display system.

### SUMMARY OF THE INVENTION

According to the present invention, there is provided a virtual reality display system comprising a first display, a second display and a third display, the first display having a three-dimensional display volume and including a plurality of projectors for projecting a three-dimensional image into the display volume, and the second display including at least one substantially translucent display screen and means for displaying an image on the display screen.

The third display may be a holographic display, or alternatively may be any other kind of display, including known two-dimensional displays such as a TV display screen or a projector and screen.

A viewer located within the display volume of the first display can see three dimensional images within the display volume. The viewer can potentially move around within the display volume to see around all sides of the three dimensional images. At the same time, the second and third displays can provide midground and background images, enhancing the illusion of a large virtual world whilst keeping the display system within a reasonably small space. Multiple translucent display screens may be included in the second display, and the translucent screen(s) may be flat or curved. The translucent display screen(s) may be, for example, a projection screen with a projector providing the means for displaying an image on the screen, or alternatively the translucent display screen(s) may be a translucent LCD or LED flat-panel display(s).

The image on the display screen of the second display may be substantially two dimensional. However, multiple translucent display screens may be placed in front of/behind each other with respect to the viewer in the display volume of the first display. In this way, the viewer is presented with motion parallax cues to give the illusion of a three-dimensional midground. Alternatively or additionally, the translucent display screen may display a stereoscopic or auto-stereoscopic three-dimensional image using known techniques which will be familiar to the skilled person.

The holographic display, where provided, may be any of a number of types of holographic display. However, it is envisaged that the holographic display is of the type having a flat display panel which provides the illusion of a three-dimensional object behind the panel. It is envisaged that the third display, which may be holographic, may be used to display background objects in the virtual world.

The screen of the second display may define part of the boundary of the display volume of the first display. In some embodiments, a translucent display screen or indeed multiple translucent display screens may define the entire boundary of the display volume, to the left, right, in front of and behind the viewer, and possibly even above and/or below the viewer as well. At least one translucent display screen may be curved, so that a single screen can extend around more than one side of the display volume of the first display. Indeed, the display volume of the first display may be substantially cylindrical or even spherical.

Preferably, the screen of the second display is disposed between the display volume of the first display and the third display. However, in some embodiments the display volume of the first display may extend somewhat behind one or more of the translucent screens.

The third display may substantially surround the entire extent of the first and second displays. The third display may surround the other displays on all four sides, and may further surround the other displays on top and/or below as well. It will be understood that the third display may in fact be made up of multiple displays, which may be located at points around the boundary of the display system, whether or not the third display substantially surrounds the other displays. In some embodiments, the third display may be made up of some holographic displays and some two-dimensional displays.

A movable surface may be provided within the display volume of the first display. For example, a treadmill or similar apparatus may be provided, or possibly a transparent ball resting on a bearing. The movable surface allows a viewer to walk, run or otherwise move around within the virtual world, whilst remaining in substantially the same physical location within the display volume of the first display. Sensors may be provided for measuring the speed and/or direction of movement on the moveable surface. Measurements from these sensors may be fed into a control system or a computer which adjusts the images displayed on each of the displays in response to the movement, providing the user with the illusion that he or she is moving around within the virtual world.

Haptic feedback apparatus may be provided for applying tactile stimulus to a person within the display volume of the first display. For example, clothing, including gloves, may be provided and may include pressure transducers. Haptic feedback apparatus may include pressure transducers and means of attaching the pressure transducers to the body of a person. For example, at least one pressure transducer may be mounted in a helmet, at least one pressure transducer may be mounted in a glove, and at least one pressure transducer may be mounted in a suit. The haptic feedback apparatus may be controlled by the computer or control system, and may be activated to provide the viewer with the sensation of touch when he or she is coincident with (i.e. ‘touching’) a three-dimensional image of a virtual object projected into the display volume of the first display.

As an alternative to, or in addition to, the moveable platform with sensors, a motion tracking camera may be provided for tracking the movements of a person within the display volume. The advantage of a motion tracking camera is that it can identify when parts of the viewer's body are moving, even when the user is stood still. For example, a motion tracking camera could identify when the viewer has reached out to touch a virtual object within the display volume, so that the control system may activate an appropriate sensation within the haptic feedback apparatus.

Additional input means may be provided to control and/or interact with the virtual world. For example, laser swords, guns etc. may be used as part of an interactive game set in the virtual world.

The virtual reality display system may be used to communicate with other real people inside the virtual world. Such a virtual reality communication system may include microphones and cameras, so that an image of a real person inside one display system may be captured and transmitted to another three dimensional display system. Speech from one user may also be captured and transmitted to another display system for reproduction on speakers. Users of the two display systems can therefore see three-dimensional images of each other, and talk to each other as if they were in the same room. It is envisaged that multiple users, in a plurality of networked display systems, may inhabit the same virtual world. When users come into proximity of each other in the virtual world, they will be able to see and hear each other, and can communicate.

It is envisaged that users of the virtual reality display system as described may be able to communicate with users using different kinds of virtual reality display system, for example, prior art virtual reality systems such as head-mounted displays. Also, communication may be possible with users having access only to standard two-dimensional displays and cameras, such as a regular laptop computer having a display screen, microphone, speakers, and webcam.

### DESCRIPTION OF THE DRAWINGS

For a better understanding of the present invention, and to show more clearly how it may be carried into effect, reference will now be made by way of example only to the accompanying drawings, in which:

FIG. 1 shows a schematic perspective view of a virtual reality display system according to the invention; and

FIG. 2 shows a schematic perspective view of a prior art immersive display system.

### DESCRIPTION OF THE PREFERRED EMBODIMENT

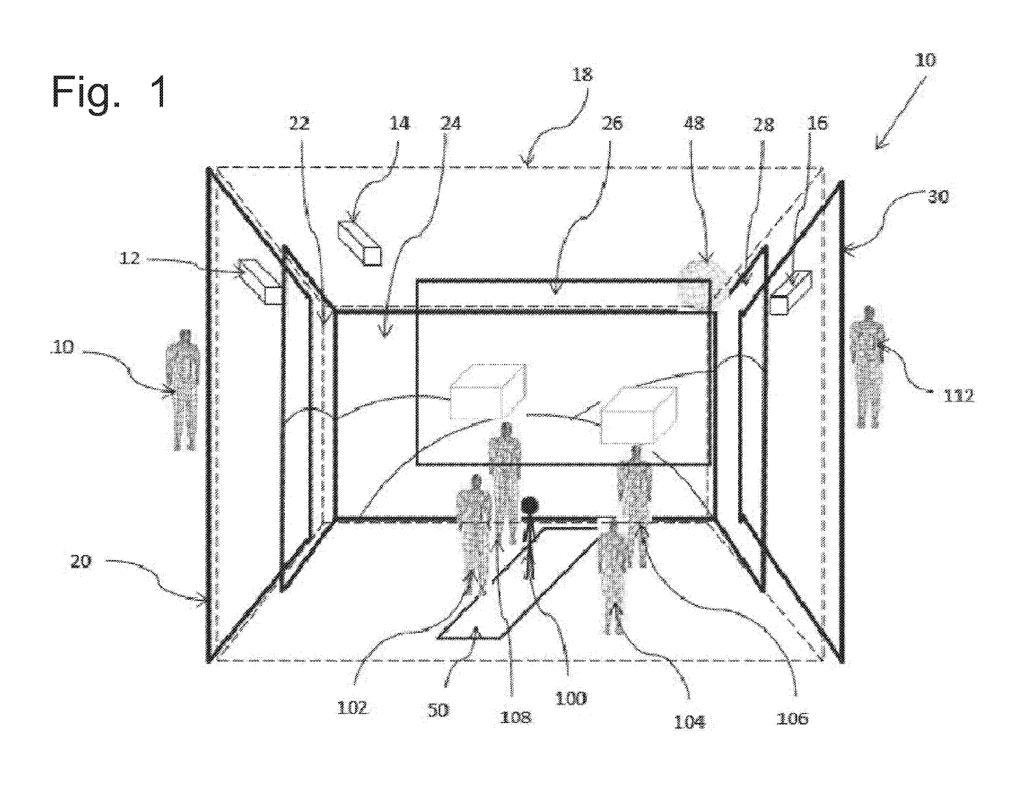

Referring to FIG. 1, a three-dimensional virtual reality platform is indicated generally at 10. The purpose of the virtual reality platform 10 is to provide a viewer 100 with a convincing illusion of movement and interaction within a virtual world.

The virtual reality platform comprises substantially three separate display systems. The first display system includes projection blocks 60, 62 which are positioned around the periphery of a display volume 18 (indicated by broken lines in the Figure). Each projection block includes a plurality of movable projectors, and each projector can be pivoted and focused to control the position of each individual image component. In this embodiment, the display volume 18 is filled with a cloud of particles and the projectors project image components into the display volume. However, it is envisaged that other types of display volume may be possible, including display volumes which do not include a cloud of particles. Each image component is two-dimensional, but the image components from the multiple projectors combine to form an image of a three-dimensional object having at least one outer surface, each image component forming an area of the outer surface. The first display system, including the structure of the projection blocks 60, 62 is described in detail in the Applicant's granted Patent GB 2497612, the disclosure in which is incorporated herein by reference.

In the example in the Figure, virtual persons 102, 104, 106, 108 are images projected into the display volume 18 of the first display system. The virtual persons 102, 104, 106, 108 can be moved around within the display system by adjusting the projectors in the projection blocks 60, 62, as described in GB 2497612.

The second display system in this embodiment comprises three translucent screens 22, 24, 28. In this example embodiment all three of the screens are flat, but it will be understood that curved screens may also be suitable. The translucent screens display mid-ground images. In the Figure, an image of some hills is displayed in front of the viewer 100. The translucent screens may include the means for displaying the image, for example they may be LCD screens. Alternatively, an image may be projected onto the translucent screens. In this embodiment, the image is projected with projectors 12, 14, 16. Projector 12 projects an image onto screen 22, projector 14 projects onto screen 24, and projector 16 projects onto screen 28. The images are ‘back projected’ in this embodiment, which is preferred because it means that the projectors are not required to be within the display volume, and can be located out-of-sight of the user 100. However, in some embodiments the images may be projected from the front of the screens.

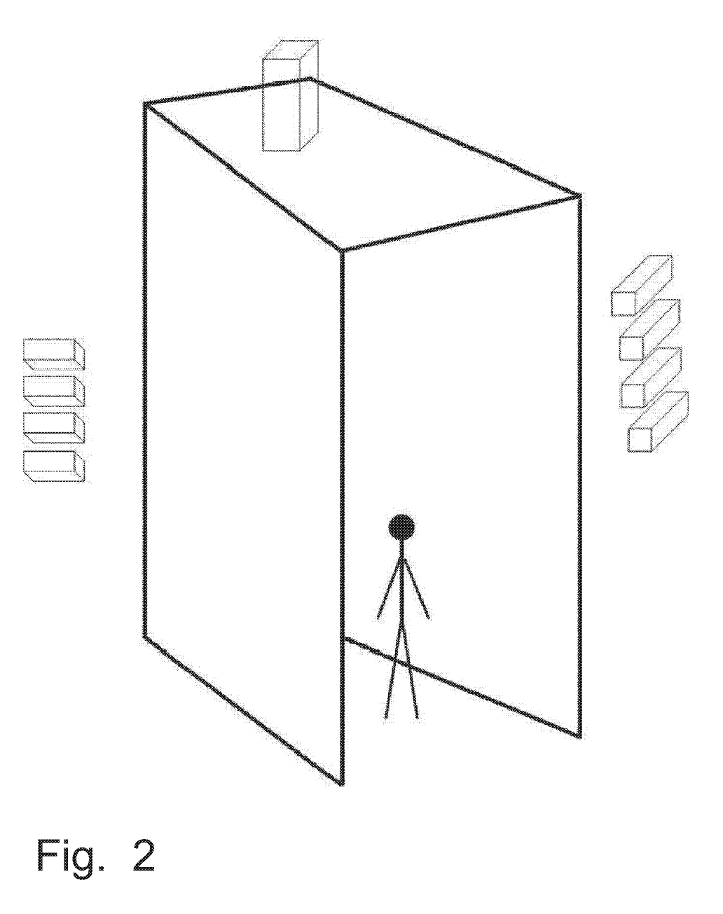

FIG. 2 shows a prior art system which makes use of translucent screens surrounding a user, but does not include the three-dimensional display volume. It can be seen that a plurality of projectors 32, 34, 36, 38, 40, 42, 44, 46 project two-dimensional images onto the translucent screens, so that the viewer 100 is effectively surrounded by display screens.

In some embodiments, more translucent display screens may be provided, and/or translucent display screens may overlap each other. Also, translucent screens may be placed within the display volume, as well as outside the display volume or on the periphery of the display volume. Overlapping screens allow images at different ‘depths’ in the virtual world to be projected, enhancing the virtual reality experience.

The third display system in this embodiment includes three holographic displays 20, 26, 30. Each holographic display includes a substantially flat screen, each disposed partly behind a translucent display screen of the second display system. Although the holographic display screens 20, 26, 30 are in reality flat, three dimensional images are displayed on the screen which have the appearance of being located some distance behind the screen. In this embodiment, globe 48 is displayed on holographic display screen 26, person 110 is displayed on holographic display screen 20, and another person 112 is displayed on holographic display screen 30. A user can look through the translucent display screens to see three-dimensional background objects. Using the holographic displays as a background helps to create the illusion of a large virtual world, within a relatively small physical space. Nevertheless, two-dimensional displays may be provided as an alternative in some embodiments.

The viewer 100 is provided with a treadmill 50. The viewer can walk or run on the treadmill and the speed at which he is moving will be detected by sensors. The sensors feed into a virtual world control system, which may be software running on a general purpose computer, and the control system may then control the images displayed on the various display screens to create the illusion that the user is walking or running within a virtual world. In this embodiment the user is only able to run in a single direction, but may be able to, for example, choose whether to turn left or right at a fork by means of a control pad or other input means. In other embodiments, the movable surface may allow movement in substantially all directions, allowing the viewer to explore the virtual world in all directions.

One example of an application for the virtual reality display system is as part of a running machine. A user may run on a treadmill within the display volume, whilst experiencing the illusion that he or she is running on an outdoor trail. Furthermore, the ‘difficulty’ of the run may be adjusted by applying a multiplier to the real distance run when controlling the virtual display. For example, with a multiplier of 10, 10 m run on the treadmill would cause the runner to ‘move’ 100 m within the virtual world. On a more difficult setting, say with a multiplier of 0.5, the runner would have to run 100 m on the treadmill to ‘move’ 50 m in the real world.

The display system which includes different types of display, spatially separated by depth, provides an immersive virtual reality experience, creating the illusion of a large virtual world, but within a relatively small physical space.

The embodiments described above are provided by way of example only, and various changes and modifications will be apparent to persons skilled in the art without departing from the scope of the present invention as defined by the appended claims.

1. A virtual reality display system comprising a first display, a second display and a third display, the first display having a three-dimensional display volume and including a plurality of projectors for projecting a three-dimensional image into the display volume, and the second display including at least one substantially translucent display screen and means for displaying an image on the display screen.

2. A virtual reality display system as claimed in claim 1, in which the third display is a holographic display.

3. A virtual reality display system as claimed in claim 1, in which the third display is a two-dimensional display.

4. A virtual reality display system as claimed in claim 1, in which the screen of the second display defines part of a boundary of the display volume of the first display.

5. A virtual reality display system as claimed in claim 1, in which the screen of the second display is disposed between the display volume of the first display and the third display.

6. A virtual reality display system as claimed in claim 5, in which the display volume of the first display is substantially surrounded by screen(s) of the second display.

7. A virtual reality display system as claimed in claim 6, in which the display volume of the first display and the screen(s) of the second display are substantially surrounded by the third display.

8. A virtual reality platform, including the virtual reality display system of claim 1, and a movable surface within the display volume of the first display.

9. A virtual reality platform as claimed in claim 8, in which speed and direction sensors are provided for measuring the speed and direction of movement on the movable surface.

10. A virtual reality platform as claimed in claim 8, in which haptic feedback apparatus are provided for applying tactile stimulus to a person within the display volume of the first display.

11. A virtual reality platform as claimed in claim 10, in which the haptic feedback apparatus includes pressure transducers, and means of attaching the pressure transducers to the body of a person.

12. A virtual reality platform as claimed in claim 11, in which at least one pressure transducer is mounted in a helmet.

13. A virtual reality platform as claimed in claim 11, in which at least one pressure transducer is mounted in a glove.

14. A virtual reality platform as claimed in claim 11, in which at least one pressure transducer is mounted in a suit.

15. A virtual reality platform as claimed in claim 11, in which at least one pressure transducer is mounted in armour.

16. A virtual reality platform as claimed in claim 9, in which a control system is provided, the control system reading inputs from the speed and direction sensors, and the control system adjusting the images on each of the first, second and third displays in response to the inputs from the sensors so as to create an illusion of movement within a virtual world.

17. A virtual reality platform as claimed in claim 16, in which the control system is further provided with input from a motion tracking camera.

18. A virtual reality platform as claimed in claim 16, in which the control system is adapted to activate haptic feedback apparatus in response to a detected position of a user.

19. A virtual reality platform as claimed in claim 18, in which the haptic feedback apparatus are activated when any part of the user's body is coincident with a three-dimensional image projected into the display volume of the first display.

20-21. (canceled)
